(19) United States
(12) Patent Application Publication
(10) Pub. No.: US 2008/0253470 A1
(43) Pub. Date: Oct. 16, 2008

(54) OFDM receiving circuit having multiple demodulation paths

(76) Inventors: Seung Wook Lee, Seoul (KR); Joonbae Park, Seoul (KR); Jeong Woo Lee, Seoul (KR); Su Won Kang, Seoul (KR); Kyeongho Lee, Seoul (KR)

Correspondence Address: Rene A. Vazquez;Williams Mullen, 8270 Greensboro Drive, Suite 700, McLean, VA, 22102, US

(21) Appl. No.: 11/976,910

(22) Filed: Oct. 29, 2007

(30) Foreign Application Priority Data
Oct. 30, 2006 (KR) 10-2006-0105467

(51) Int. Cl. H04L 27/28

(52) U.S. Cl. 375/260

(57) ABSTRACT

Embodiments according to the application relate to an OFDM (orthogonal frequency division multiplexing) receiving circuit and methods thereof configured to have a plurality of demodulation paths, which can increase or improve a performance of an ADC and/or a filter.

### CROSS-REFERENCE TO RELATED APPLICATIONS

This application claims priority under 35 U.S.C. § 119 (a) of Korean Patent Application No. 10-2006-0105467, filed on Oct. 30, 2006, in the Korean Intellectual Property Office, the disclosure of which is incorporated herein by reference in its entirety.

### BACKGROUND OF THE INVENTION

1. Field of the Invention

The present general inventive concept relates to an OFDM (orthogonal frequency division multiplexing) receiving circuit, and more particularly to an OFDM receiving circuit having a plurality of demodulation paths to improve a performance an ADC and a filter.

2. Background of the Related Art

An OFDM is a type of a multi-carrier modulation, where a symbol array inputted in series is converted into a parallel form by N block unit, then each element symbol is modulated into a sub-carrier having a mutual orthogonality, and then the sub-carriers are added for transmission. The OFDM is robust to a multiple path fading occurring in a wireless communication environment and is capable of a high speed data transmission. Accordingly, use of the OFDM is increasing. The OFDM is used as a transmission method of a wireless LAN (e.g., IEEE 802.11a), Wibro (wireless broadband), WiMAX (World Interoperability for Microwave Access) and a terrestrial DMB (Digital Multimedia Broadcasting).

FIG. 1 is a diagram illustrating a conventional OFDM receiving circuit. As illustrated in FIG. 1, the conventional OFDM receiving circuit includes a low noise amplifier 11, a down-conversion mixer 13, a variable gain amplifier 15, a filter 17, an ADC (analog-to-digital converter) 19, a demodulator 21 and a local oscillator 23.

The conventional OFDM receiving circuit shown in FIG. 1 has a single demodulation path similar to other receiving circuits such as a CDMA receiving circuit. The single demodulation path refers to the single filter 17 (although the filter 17 is divided into an I channel filter and a Q channel filter, the I channel filter and the Q channel filter are regarded as the single filter 17 for convenience), the single ADC 19 (although the ADC 19 is divided into an I channel ADC and a Q channel ADC, the I channel ADC and the Q channel ADC are regarded as the single ADC 19 for convenience) and the single demodulator 21 for an OFDM signal band. For example, in the Wibro standard, the single filter 17, the single ADC 19 and the single demodulator 21 are used for an OFDM signal having a bandwidth of 8.5 MHz and including 841 sub-carriers.

On the other hand, a performance of the ADC 19, and in particular a dynamic range thereof, is degraded as a sampling rate increases. However, since the OFDM compliant to the Wibro standard has a signal band of 8.5 MHz, a much higher sampling rate is required compared to a CDMA compliant to the IS95 standard having a signal band of 1.25 MHz. Therefore, the ADC 19 of the OFDM receiving circuit having the single demodulation path shown in FIG. 1 is disadvantageous in that the dynamic range thereof is reduced because of the high sampling rate (or wide signal band).

Moreover, a characteristic of the filter 17 is degraded as the signal band increases. More specifically, in order to improve a noise characteristic, an active RC filter including an operational amplifier should be used. A frequency characteristic of the operational amplifier is determined by an UGB (unity gain bandwidth), which should generally be increased proportional to the signal band to maintain the frequency characteristic. A distortion occurring when an ideal frequency response and the UGB of the filter 17 of the OFDM receiver having the signal demodulation path are lower than an appropriate value is shown in FIG. 2. In order not to degrade the frequency characteristic, the UGB should be increased. However, the increase of the UGB requires an increase in power consumption. As a result, a problem occurs in that the frequency characteristic is degraded as the signal band is increased or that the power consumption is increased in order to maintain the frequency characteristic. Therefore, one of the frequency characteristic and the power consumption should be sacrificed since the filter 17 of the OFDM receiver having the single demodulation path should be capable of operating in a wide signal range.

The above references are incorporated by reference herein where appropriate for appropriate teachings of additional or alternative details, features and/or technical background.

### SUMMARY OF THE INVENTION

An object of the present general inventive concept is to solve at least the above problems and/or disadvantages or to provide at least the advantages and/or utilities described hereinafter in whole or in part.

Another object of the application is to provide an OFDM receiver that can reduce a sampling rate of an ADC to improve a dynamic range thereof, which can increase an overall performance of the receiving circuit.

Another object of the application is to provide an OFDM receiving circuit that can reduce a bandwidth of a signal to improve a frequency characteristic (or a power consumption) of a filter.

To achieve objects and/or utilities of embodiments of the application in whole or in part, there is provided an OFDM receiving circuit that can include a low noise amplifier for subjecting a received OFDM signal to an amplification, a down-conversion mixer for down-converting an output signal being outputted from the low noise amplifier, a plurality of demodulation paths for receiving an output signal of the down-conversion mixer, and for outputting a plurality of data, wherein a band of the OFDM signal is divided into a plurality of bands, each of the plurality of bands including a plurality of sub-carriers, and each of the plurality of demodulation paths outputs a data of the plurality of data obtained by selecting a signal in one of the plurality of bands corresponding to each of the plurality of demodulation paths, and subjecting the selected signal to a digital conversion and a demodulation and a combiner for combining the plurality of data being outputted from the plurality of demodulation paths.

Each of the plurality of demodulation paths can include a filter for passing through the signal in the one of the plurality of bands corresponding to each of the plurality of demodulation paths an ADC for carrying out the digital conversion of an output of the filter and a demodulator for demodulating an output of the ADC.

To also achieve objects and/or utilities of embodiments of the application in whole or in part, there is provided an OFDM receiving method that can include (a) subjecting an received OFDM signal to an amplification, (b) down-converting the amplified OFDM signal using a mixer, (c) obtaining a plurality of digital signals from the down-converted OFDM signal, wherein a band of the OFDM signal is divided into a plurality of bands, and each of the plurality of digital signals is obtained by subjecting a signal in one of the plurality of bands corresponding to each of the plurality of digital signals to a digital conversion, (d) demodulating the plurality of digital signals to obtain a plurality of data and (e) combining the plurality of data to obtain a demodulated data corresponding to the received OFDM signal.

Obtaining a plurality of digital signals can include (c1) inputting the down-converted OFDM signal to a plurality of filters having different pass bands to obtain a plurality of signals having different signal bands and (c2) inputting the plurality of signals having the different signal bands to a plurality of ADCs to obtain the plurality of digital signals.

To also achieve objects and/or utilities of embodiments of the application in whole or in part, there is provided an OFDM receiving circuit that can include a low noise amplifier to amplify a received OFDM signal to an amplification, a plurality of demodulation paths to receive an output signal of the low noise amplifier and to output a plurality of data, wherein a band of the OFDM signal comprises a plurality of bands each to include a plurality of sub-carriers, and each of the plurality of demodulation paths to select a signal in a band corresponding to said each of the plurality of demodulation paths from a down-converted signal of the low noise amplifier and to subject the selected signal to a digital conversion and a demodulation to output a data of the plurality of data and a combiner to combine the plurality of data from the plurality of demodulation paths.

To also achieve objects and/or utilities of embodiments of the application in whole or in part, there is provided an OFDM receiving method that can include amplifying an received OFDM signal, obtaining a plurality of digital signals from the amplified OFDM signal, wherein a band of the OFDM signal is divided into a plurality of bands, each of the plurality of bands to include a plurality of sub-carriers, and each of the plurality of digital signals is obtained by down-converting the amplified OFDM signal and subjecting a signal of the down-converted OFDM signal in one of the plurality of bands corresponding to each of the plurality of digital signals to a digital conversion, demodulating the plurality of digital signals to obtain a plurality of data and combining the plurality of data to obtain a demodulated data corresponding to the received OFDM signal.

To also achieve objects and/or utilities of embodiments of the application in whole or in part, there is provided an OFDM receiving circuit that can include a low noise amplifier to amplify a received OFDM signal, a plurality of demodulation paths to receive the OFDM signal from the low noise amplifier and to output a plurality of data, wherein a band of the OFDM signal is divided into a plurality of bands, each of the plurality of bands is configured to include a plurality of sub-carriers, and the plurality of demodulation paths comprises at least one first demodulation path to process a first band of the plurality of bands and at least one second demodulation path to process a second band of the plurality of bands different from the first band and a combiner to combine the plurality of data from the plurality of demodulation paths.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a diagram illustrating a conventional OFDM receiving circuit.

FIG. 2 is a diagram illustrating a distortion when an ideal frequency response and a unity gain bandwidth of a filter of an OFDM receiver having a signal demodulation path are lower than an appropriate value.

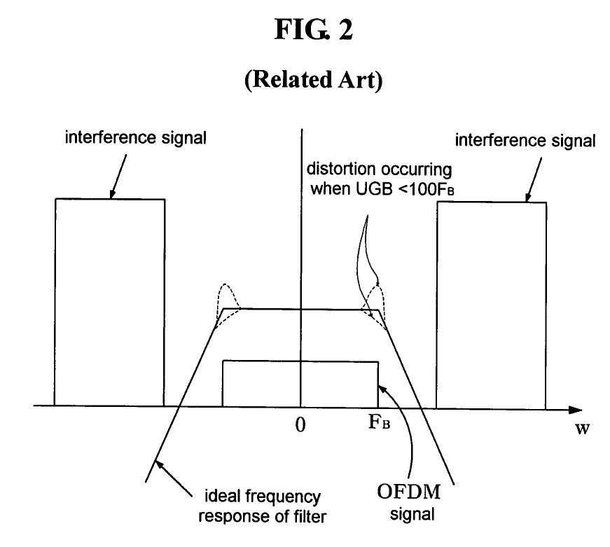

FIG. 3 is a diagram illustrating an OFDM receiving circuit in accordance with a first embodiment according to the application wherein the OFDM receiving circuit having three modulation paths is shown.

FIG. 4 is a diagram illustrating a frequency response of each of a first filter 37A, a second filter 37B and a third filter 37C.

FIG. 5 is a diagram illustrating an OFDM receiving circuit in accordance with a second embodiment according to the application wherein the OFDM receiving circuit having three modulation paths is shown.

### DETAILED DESCRIPTION OF EMBODIMENTS

Exemplary embodiments according to the present general inventive concept will now be described in detail with reference to the accompanied drawings. The interpretations of the terms and wordings used in description and claims should not be limited to common or literal meanings. Exemplary embodiments of the application are provided to describe the present general inventive concept more thoroughly for those skilled in the art.

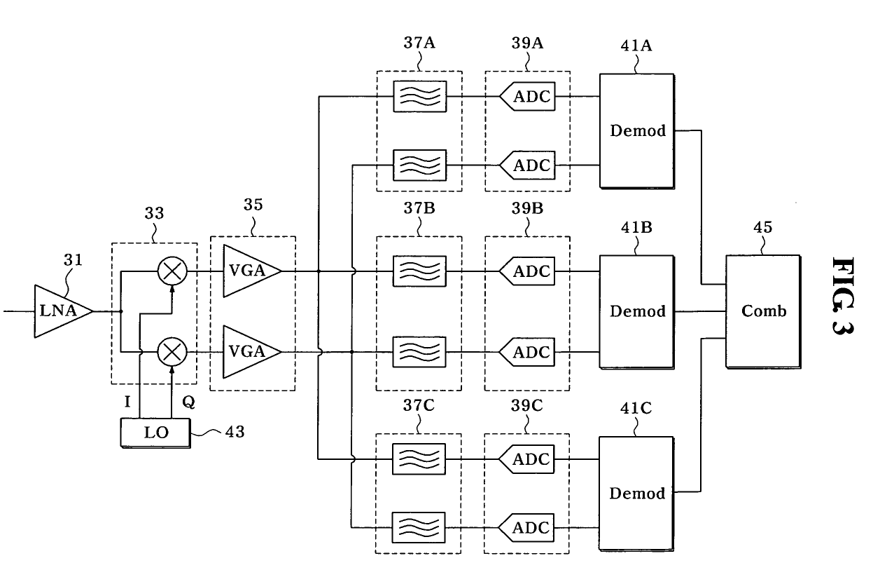

FIG. 3 is a diagram illustrating an OFDM receiving circuit in accordance with a first embodiment of the application. As illustrated in FIG. 3, the OFDM receiving circuit is configured to have three modulation paths. However, embodiments of the application are not intended to be limited by such an exemplary disclosure.

As illustrated in FIG. 3, the OFDM receiving circuit can include a low noise amplifier 31, a down-conversion mixer 33, a variable gain amplifier 35, a plurality of filters 37A, 37B and 37C, a plurality of ADCs 39A, 39B and 39C, a plurality of demodulators 41A, 41B and 41C, a local oscillator 43 and a combiner 45. A first demodulation path of the three demodulation paths can include the first filter 37A, the first ADC 39A and the first demodulator 41A, a second demodulation path of the three demodulation paths can include the second filter 37B, the second ADC 39B and the second demodulator 41B, and a third demodulation path of the three demodulation paths can include the third filter 37C, the third ADC 39C and the third demodulator 41C.

The low noise amplifier 31 subjects a received RF signal to a low noise amplification and transmits the amplified signal to the down-conversion mixer 33. Although not shown, an additional amplifier may be disposed between the low noise amplifier 31 and the down-conversion mixer 33.

The down-conversion mixer 33 down-converts the received RF signal transmitted from the low noise amplifier 31 and outputs the down-converted signal. In order to achieve this, the down-conversion mixer 33 preferably outputs a value obtained by multiplying the received RF signal by an in-phase signal being outputted by the local oscillator 43 and a value obtained by multiplying the received RF signal by a quadrature signal being outputted by the local oscillator 43.

The variable gain amplifier 35, which is a type of an amplifier, amplifies an output signal of the down-conversion mixer 33 and outputs the amplified output signal. The variable gain amplifier 35 may be omitted. In addition, the variable gain amplifier 35 may be implemented such that a variable gain amplifier is disposed in front of or behind each of the three filters 37A, 37B and 37C. For example, since the OFDM receiving circuit of FIG. 3 has the three modulation paths, three variable gain amplifiers may be required. Each of the three variable gain amplifiers may have different gain. In addition, the variable gain amplifier 35 may be disposed between the down-conversion mixer 33 and the filters 37A, 37B and 37C, and/or between the filters 37A, 37B and 37C and the ADCs 39A, 39B and 39C.

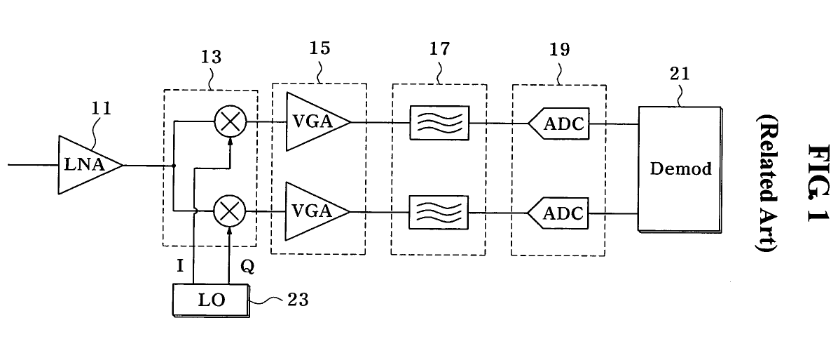

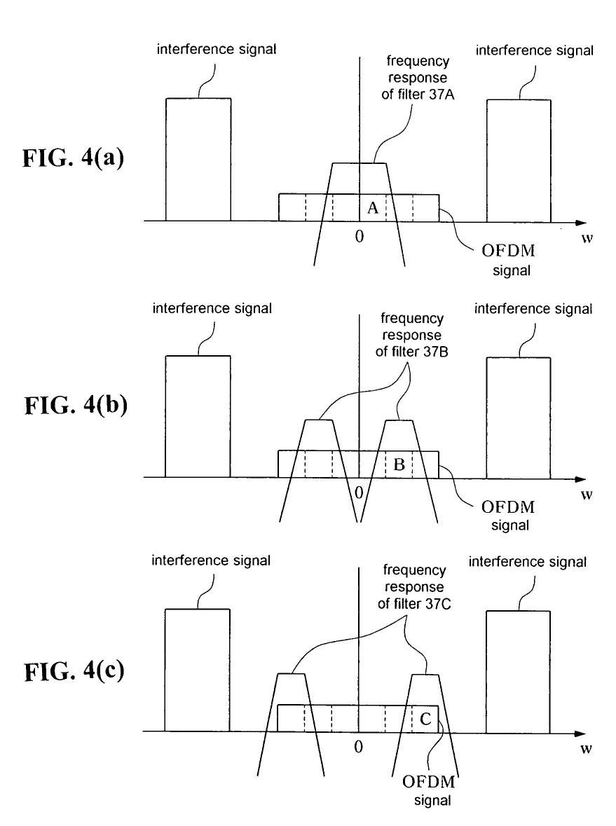

Each of the filters 37A, 37B and 37C can selectively output a signal of a predetermined band of the output signal of the variable gain amplifier 35. Frequency responses of the first filter 37A, the second filter 37B and the third filter 37C are shown in FIGS. 4a, 4b and 4c, respectively. As shown in FIG. 4a, the first filter 37A can be a low pass filter to selectively output a predetermined number of sub-carriers A having a low frequency from the received OFDM signal (e.g., including a total of 841 sub-carriers). As shown in FIG. 4b, the second filter 37B can be a band pass filter to selectively output a predetermined number of sub-carriers B having an intermediate frequency from the received OFDM signal (e.g., including the total of 841 sub-carriers). As shown in FIG. 4c, the third filter 37C can be a band pass filter to selectively output a predetermined number of sub-carriers C having a high frequency from the received OFDM signal (e.g., including the total of 841 sub-carriers). The filters 37A, 37B and 37C may selectively output a same number of the sub-carriers or a similar number of the sub-carriers. For example, each of the filters may selectively output a number of sub-carriers close to 841/3. For instance, the first filter, the second filter and the third filter may selectively output 260, 260 and 261 sub-carriers, respectively. Alternatively, the filters 37A, 37B and 37C may output different numbers of the sub-carriers. For instance, the number of the sub-carriers may increase from the first filter to the third filter. In one embodiment, the first filter, the second filter and the third filter may selectively output 200, 260 and 321 sub-carriers, respectively. Contrarily, the number of the sub-carriers may decreases from the first filter to the third filter. In one embodiment, the first filter, the second filter and the third filter may selectively output 320, 260 and 201 sub-carriers, respectively. In any case, a bandwidth of a pass band of each of the filters 37A, 37B and 37C is much smaller than that of the filter 17 of FIG. 1. Therefore, a characteristic of each of the filters 37A, 37B and 37C is improved compared to that of the filter 17 of FIG. 1.

The ADCs 39A, 39B and 39C can convert the output signals of the filters 37A, 37B and 37C to digital signals. Since there are three demodulation paths, a bandwidth of a signal being inputted to each of the ADCs 39A, 39B and 39C is greatly reduced (to about ⅓) compared to the conventional art. Therefore, a sampling rate of the ADC 39 is greatly reduced, and a dynamic range of the ADC 39 is improved accordingly. The ADC 39 may be a nyquist rate ADC or may be a sigma-delta ADC that carries out an oversampling, etc. When an oversampling ADC is used as the ADC 39, an RC passive filter may be used as the filter (e.g., filter 37). In addition, when the oversampling ADC is used as the ADC 39, the ADC 39 itself may have a filtering function, and the filter 37 may be omitted. Moreover, it is preferable that a digital filter (not shown) is disposed between the ADC 39 and the demodulator 41 when the oversampling ADC is used as the ADC 39.

The demodulators 41A, 41B and 41C respectively receive the signals being outputted from the ADCs 39A, 39B and 39C and carry out a demodulation. The demodulator 41 can carry out a FFT (fast Fourier transform) to extract a data included in the sub-carriers being inputted thereto, and transmit the extracted data to the combiner 45. For example, the first demodulator 41A can receive the predetermined number of the sub-carriers A having the low frequency of the OFDM signal (e.g., having the total of 841 sub-carriers), and transmit the data obtained by the demodulation to the combiner 45. The second demodulator 41B can receive the predetermined number of the sub-carriers B having the intermediate frequency of the OFDM signal (e.g., having the total of 841 sub-carriers), and transmit the data obtained by the demodulation to the combiner 45. The third demodulator 41C can receive the predetermined number of the sub-carriers C having the high frequency of the OFDM signal (e.g., having the total of 841 sub-carriers), and transmit the data obtained by the demodulation to the combiner 45.

The combiner 45 can output received data for an OFDM signal band obtained by combining the data being outputted from the demodulators 41A, 41B and 41C.

The local oscillator 43 provides the in-phase signal and the quadrature signal to the down-conversion mixer 33.

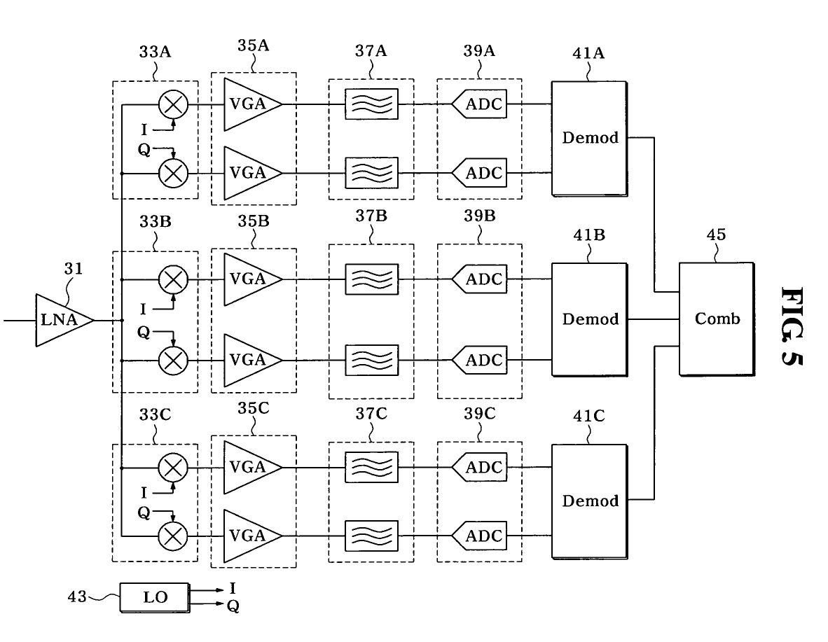

FIG. 5 is a diagram illustrating an OFDM receiving circuit in accordance with a second embodiment according to the application. In this embodiment, the OFDM receiving circuit can have three modulation paths.

Referring to FIG. 5, the OFDM receiving circuit can include a low noise amplifier 31, a plurality of down-conversion mixers 33A, 33B and 33C, a plurality of variable gain amplifiers 35A, 35B and 35C, a plurality of filters 37A, 37B and 37C, a plurality of ADCs 39A, 39B and 39C, a plurality of demodulators 41A, 41B and 41C, a local oscillator 43 and a combiner 45. A first demodulation path of the three demodulation paths preferably includes the first down-conversion mixer 33A, the first variable gain amplifier 35A, the first filter 37A, the first ADC 39A and the first demodulator 41A. A second demodulation path of the three demodulation paths preferably includes the second down-conversion mixer 33B, the second variable gain amplifier 35B, the second filter 37B, the second ADC 39B and the second demodulator 41B, and a third demodulation path of the three demodulation paths preferably includes the third down-conversion mixer 33C, the third variable gain amplifier 35C, the third filter 37C, the third ADC 39C and the third demodulator 41C.

Since the OFDM receiving circuit shown in FIG. 5 is identical to the OFDM receiving circuit shown in FIG. 3 except that the demodulation path starts at the down-conversion mixers 33A, 33B and 33C, a detailed description of each component of the OFDM receiving circuit shown in FIG. 5 is omitted here.

While the OFDM receiving circuit having the three demodulation paths is described above, two or more demodulation paths are sufficient. For example, four or more of the demodulation paths may be used. Further, although the description and claims can refer to “a band of the OFDM signal is divided into a plurality of bands A, B and C”, the description and claims are not limited to a case that a sum of the plurality of bands A, B and C is the band of the OFDM signal. For example, the sum of the plurality of bands may be the same as or less than the band of the OFDM signal, the plurality of bands A, B and C may overlap or the like.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

As described above, embodiments of the OFDM receiving circuit and methods in accordance with the present general inventive concept include a plurality of demodulation paths such that an overall performance of the OFDM receiving circuit can be improved. Embodiments of the application can reduce a sampling rate of each of the DACs and/or increase the dynamic range of the ADC.

In addition, an OFDM receiving circuit or method in accordance with the application include a plurality of demodulation paths such that the pass band width of each filter is reduced, the frequency characteristic of the filter or a power consumption is improved, which can improve an overall performance of the OFDM receiving circuit.

Particularly, in accordance with the conventional CDMA, since a CDMA signal is diffused for an entire band, a filtering, a digital conversion and a demodulation cannot be carried out for each frequency. However, in accordance with the application, since the band of the OFDM signal is divided into the plurality of sub-carriers, it is possible to process the OFDM signal by dividing the OFDM signal into the plurality of bands. The present general inventive concept takes advantage of such characteristic of the OFDM signal such that the filtering, the digital conversion and the demodulation can be carried out by dividing the OFDM signal into the plurality of bands, which can improve the performance of a filter and/or ADC.

The foregoing embodiments and advantages are merely exemplary and are not to be construed as limiting the present general inventive concept. The present teaching can be readily applied to other types of apparatuses. The description of the present general inventive concept is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. As used in this disclosure, the term “preferably” is non-exclusive and means “preferably, but not limited to.” Terms in the claims should be given their broadest interpretation consistent with the general inventive concept as set forth in this description. For example, the terms “coupled” and “connect” (and derivations thereof) are used to connote both direct and indirect connections/couplings. As another example, “having” and “including”, derivatives thereof and similar transitional terms or phrases are used synonymously with “comprising” (i.e., all are considered “open ended” terms)—only the phrases “consisting of” and “consisting essentially of” should be considered as “close ended”. Claims are not intended to be interpreted under 112 sixth paragraph unless the phrase “means for” and an associated function appear in a claim and the claim fails to recite sufficient structure to perform such function.

What is claimed is:

1. An OFDM receiving circuit comprising:
a low noise amplifier to amplify a received OFDM signal to an amplification;
a plurality of demodulation paths to receive an output signal of the low noise amplifier and to output a plurality of data, wherein a band of the OFDM signal comprises a plurality of bands each to include a plurality of sub-carriers, and each of the plurality of demodulation paths to select a signal in a band corresponding to said each of the plurality of demodulation paths from a down-converted signal of the low noise amplifier and to subject the selected signal to a digital conversion and a demodulation to output a data of the plurality of data; and
a combiner to combine the plurality of data from the plurality of demodulation paths.

2. The circuit in accordance with claim 1, wherein said each of the plurality of demodulation paths comprises:
a down-conversion mixer to down-convert the output signal of the low noise amplifier;
a filter to pass the signal of output signals of the down-conversion mixer in the band corresponding to one of the plurality of demodulation paths;
an ADC to digitally convert of an output of the filter; and
a demodulator to demodulate an output of the ADC.

3. The circuit in accordance with claim 2, wherein a pass band of the filter is configured to match the band corresponding to each of the plurality of demodulation paths.

4. The circuit in accordance with claim 1, comprising a single down-conversion mixer to down-convert an output signal of the low noise amplifier or a plurality of down-conversion mixers each in a corresponding one of the plurality of demodulation paths.

5. The circuit in accordance with claim 4, comprising an amplifier connected between the down-conversion mixer and the filter, the amplifier to amplify the output signal of the down-conversion mixer to be inputted to the filter.

6. An OFDM receiving method comprising:
amplifying an received OFDM signal;
obtaining a plurality of digital signals from the amplified OFDM signal, wherein a band of the OFDM signal is divided into a plurality of bands, each of the plurality of bands to include a plurality of sub-carriers, and each of the plurality of digital signals is obtained by down-converting the amplified OFDM signal and subjecting a signal of the down-converted OFDM signal in one of the plurality of bands corresponding to each of the plurality of digital signals to a digital conversion;
demodulating the plurality of digital signals to obtain a plurality of data; and
combining the plurality of data to obtain a demodulated data corresponding to the received OFDM signal.

7. The method in accordance with claim 6, wherein the obtaining comprises:
inputting the amplified OFDM signal to a plurality of down-conversion mixer to obtain a plurality of down-converted OFDM signals;
inputting the plurality of down-converted OFDM signals to a plurality of filters configured to have different pass bands to obtain a plurality of signals having different signal bands; and
inputting the plurality of signals having the different signal bands to a plurality of ADCs to obtain the plurality of digital signals.

8. The method in accordance with claim 6, comprising down-converting the amplified OFDM signal using a single mixer.

9. The method in accordance with claim 6, comprising amplifying the down-converted OFDM signal.

10. An OFDM receiving circuit comprising
a low noise amplifier to amplify a received OFDM signal;
a plurality of demodulation paths to receive the OFDM signal from the low noise amplifier and to output a plurality of data, wherein a band of the OFDM signal is divided into a plurality of bands, each of the plurality of bands is configured to include a plurality of sub-carriers, and the plurality of demodulation paths comprises at least one first demodulation path to process a first band of the plurality of bands and at least one second demodulation path to process a second band of the plurality of bands different from the first band; and
a combiner to combine the plurality of data from the plurality of demodulation paths.

11. The circuit in accordance with claim 10, wherein each of the first demodulation path and the second demodulation path comprises:
a down-conversion mixer to down-convert the OFDM signal from the low noise amplifier;
a filter to pass through a signal of an output signal of the down-conversion mixer in a corresponding band of the demodulation path;
an ADC to digitally convert a OFDM signal from the filter; and
a demodulator to demodulate an output of the ADC.

12. The circuit in accordance with claim 10, wherein each of the first demodulation path and the second demodulation path comprises:
a filter to pass through a signal of an output signal of the down-conversion mixer in a corresponding band of the demodulation path;
an ADC to digitally convert a OFDM signal from the filter; and
a demodulator to demodulate an output of the ADC.
